(19) United States
(12) Patent Application Publication
(10) Pub. No.: US 2004/0108494 A1
(43) Pub. Date: Jun. 10, 2004

(54) Low clearance vehicle lift/stand

(76) Inventor: Lamont D. Garrelts, Elgin, IL (US)

Correspondence Address: DILLIS V. ALLEN, Suite 101, 105 S. Roselle Road, Schaumburg, IL, 60007, US

(21) Appl. No.: 10/313,229

(22) Filed: Dec. 5, 2002

(51) Int. Cl. B66F 3/00

(52) U.S. Cl. 254/8 B

(57) ABSTRACT

A low clearance vehicle (Go Kart, for example) lift/stand that raises the vehicle off the floor for convenient mechanical work. A four bar linkage slides under the vehicle frame to raise the vehicle. A multiple link system driven by the four bar linkage slides a forward wheel carriage along the lift/stand frame, which would otherwise not clear beneath the vehicle frame, forwardly under the vehicle after the vehicle is raised sufficiently by the four bar linkage. Coupled with a pair of rear wheels, these forward wheels enable the lift to be wheeled easily about the work area.

### BACKGROUND OF THE INVENTION

Vehicles, regardless of size, usually require a stand or a lift to gain access to portions of the vehicle. Production automobiles do not usually require a lift for engine work from the top, but they usually do for undercarriage work. Bicycle mechanic stands usually invert the bicycle. Snowmobiles can be raised by three roller skate type devices and by lift pulleys that are ceiling mounted.

Some vehicles present unique problems such as Go Kart type vehicles. Their frames usually have a ground clearance of only about one inch (plus) so it is difficult to get a lift under the Kart without manually lifting the Kart to an elevated stand. One man cannot do it and frequently the owner-driver-mechanic is a one man operation, particularly at the race track.

It is also desirable that Kart stands be mobile so the owner can roll the cart around the work area. The work area ground is frequently rough so large pneumatic tires are desirable. This presents an additional difficulty because large pneumatic tires cannot easily get under the low clearance Kart frame.

There is an existing Lift Kart stand found at www.grrtech.com/wannalift/technical.html. This stand has a four bar linkage that slides under the Kart frame and elevates it. The stand has only one pair of pneumatically inflated wheels because this stand does not solve the problem of forward wheel clearance. A second wheel set is provided separate from the lift which can only be installed when the cart is in the elevated position. Attachment of these forward wheels is difficult for one man. And without the forward wheels, the Wanna Kart Lift is not mobile.

It is a primary object of the present invention to ameliorate the problems noted above in lift/stands for low clearance vehicles.

### SUMMARY OF THE PRESENT INVENTION

In accordance with the present invention, a low clearance vehicle lift/stand is provided that raises the vehicle off the floor for convenient mechanical work. A four bar linkage slides under the vehicle frame and raises the vehicle. A multiple link system driven by the four bar linkage slides a carriage carrying forward wheels along the lift/stand frame, which would otherwise not clear beneath the vehicle frame, forwardly under the vehicle after the vehicle is raised sufficiently by the four bar linkage. Coupled with a pair of stationary rear wheels, these forward wheels enable the lift to be wheeled easily about the work area.

Toward these ends, the lift/stand includes a pair of spaced axial frame members on which the carriage for the forward wheels slides. As the carriage hits a stop at the forward end of the lift, the multiple link system rotates the carriage which lowers the forward wheels and lifts the front of the lift frame off the ground so the frame forward end is then supported on the forward wheels.

This unique system enables the lift with large pneumatic tires to slide under a low clearance Go Kart or similar vehicle, by one person, without lifting the vehicle onto the lift or stand.

A novel tilting mechanism atop the four bar linkage enables the vehicle to be tilted to one side for easier working.

And finally, a set of lift legs are provided that stabilize the lift/stand and the supported vehicle while carried on a truck bed.

The four bar lift mechanism may be operated by a winch, a battery powered motor, or a worm gear powered cordless tool.

### BRIEF DESCRIPTION OF THE DRAWINGS

FIG. 1 is a forward perspective view of the present low clearance vehicle lift/stand in its elevated position supporting a typical Go Kart in a 45 degree tilted position;

FIG. 2 is a left front perspective of the present low clearance vehicle lift/stand in its elevated position without the typical Go Kart illustrated in FIG. 1;

FIG. 3 is a left front perspective of the present low clearance vehicle lift/stand in its lowermost position, the position in which it slides under the vehicle frame in preparation for lifting;

FIG. 4 is a left front perspective of the present low clearance vehicle lift/stand with the four bar lifting mechanism elevated approximately 20 degrees;

FIG. 5 is a left front perspective similar to FIGS. 2, 3, and 4 with the four bar linkage further elevated and the forward wheel assembly approaching its forward stop just prior to moving to the fully upright position illustrated in FIG. 2;

FIG. 6 is a fragmentary left rear fragmentary perspective showing the power drive mechanism for the four bar linkage and the forward wheel carriage assembly;

FIG. 7 is a left side view of the present low clearance vehicle lift/stand similar to FIG. 2;

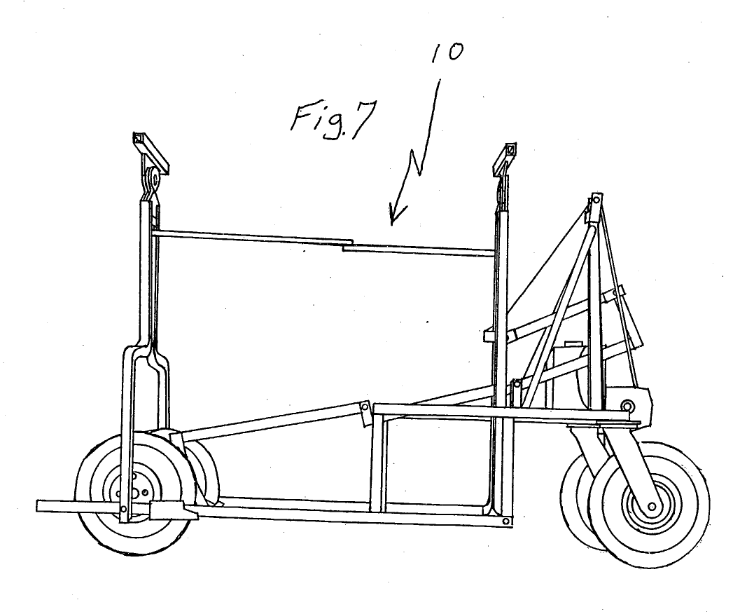

FIG. 8 is a fragmentary view of the left side lower portion of the present low clearance vehicle lift/stand showing the add-on leg members for supporting the lift/stand and a mounted Go Kart in a transport vehicle, and;

FIG. 9 is a fragmentary view of one of the angular locking assemblies for the lift cross members.

### DETAILED DESCRIPTION OF THE PREFERRED EMBODIMENT

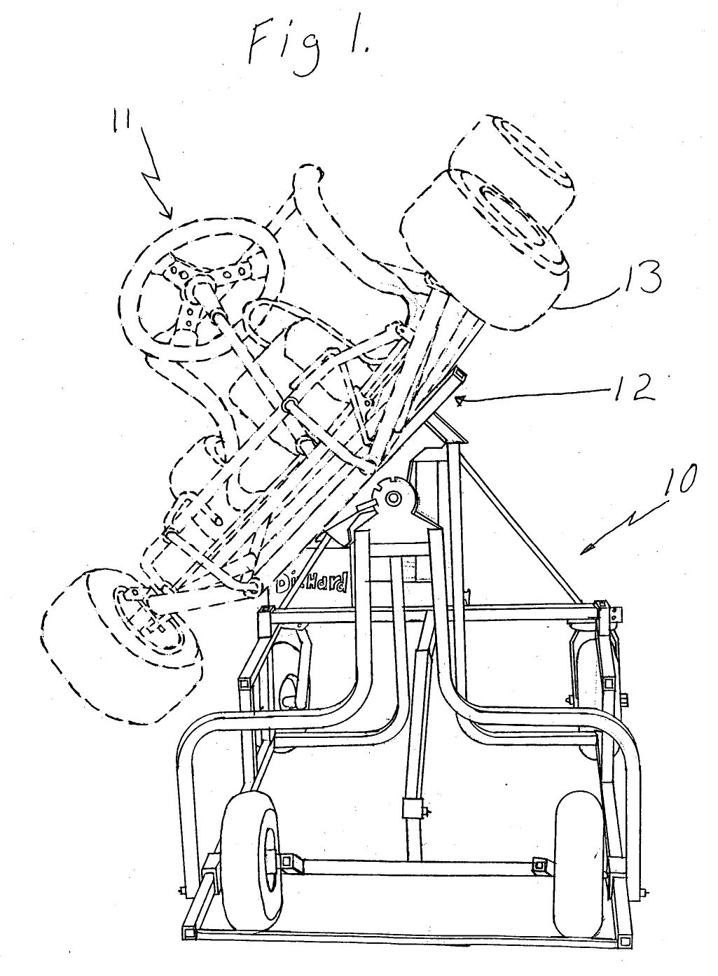

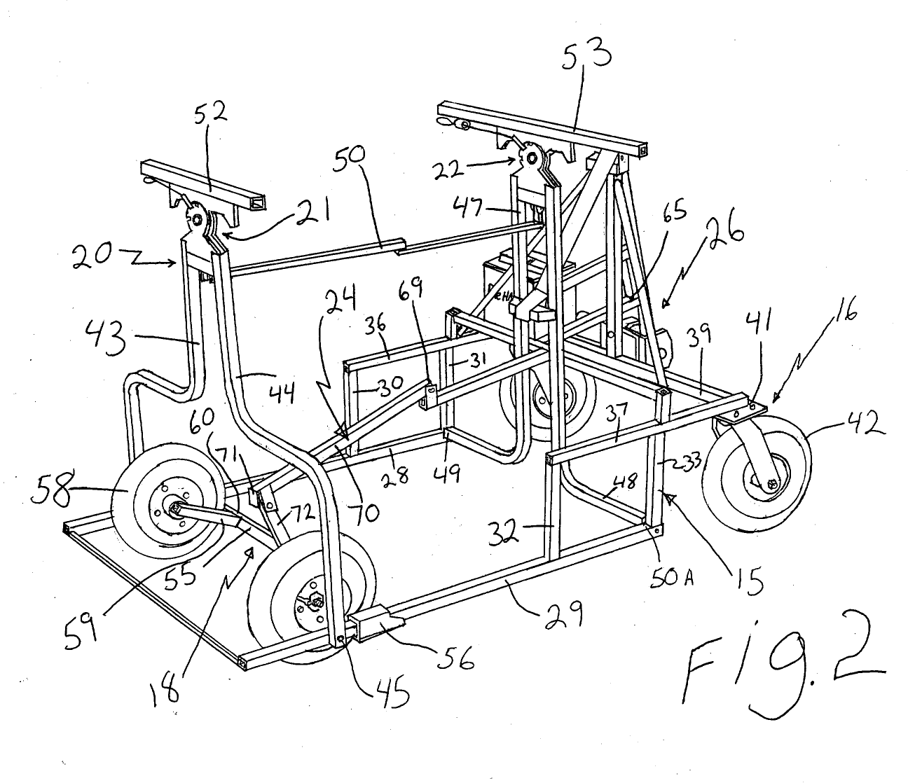

Referring to the drawings and initially FIGS. 1 and 2, a low clearance vehicle lift/stand 10 is illustrated shown in FIG. 1 supporting a Go Kart assembly 11. The Go Kart assembly 11 includes a frame 12 that has a ground clearance above the ground engaging surface 13 of the go kart wheels of somewhat over one inch, and the present lift/stand is intended to lift low clearance vehicles, such as Go Kart 11, to a workable elevation. While the present invention is particularly designed for Go Karts, it should be understood that the principles can be applied to other low clearance vehicles such as midget race cars and even snowmobiles, with certain modifications to accommodate the configuration of those vehicles.

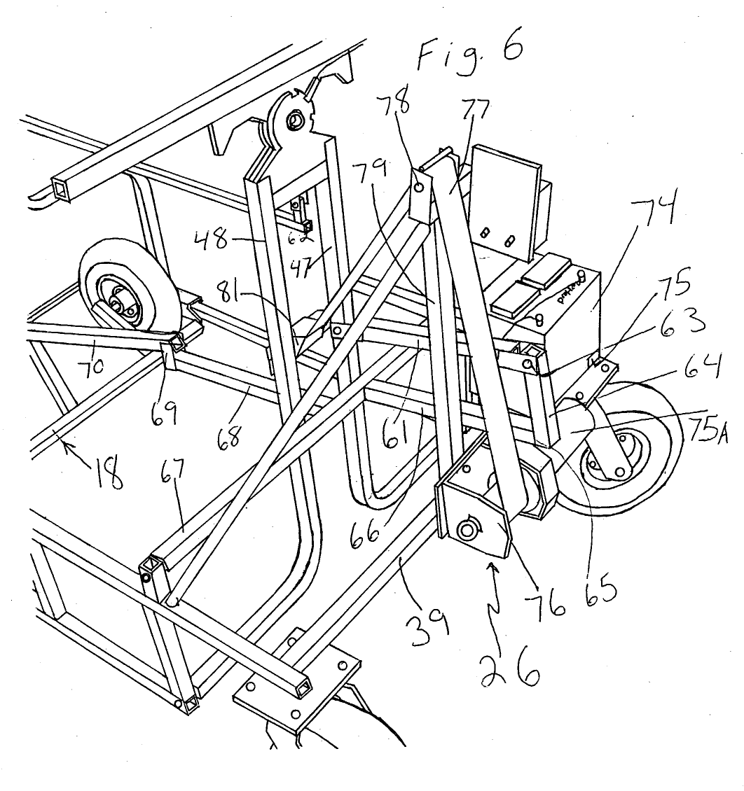

The lift/stand 10 is seen to include a frame assembly 15, a rear wheel assembly 16, a forward wheel assembly 18, a four bar lift mechanism 20 with a tilting mechanism 21, 22, for tilting the Kart to the position illustrated in FIG. 1, a forward wheel carriage movement linkage 24 and a power drive assembly 26. Note that the power drive assembly 26 illustrated in FIG. 6, for example, is a battery powered motor and motor pulley and belt actuator for the four bar linkage, but the power assembly could also take the form of a hand winch, such as used on a boat trailer or a worm gear and pinion configuration driven by a cordless power tool having sufficient power to effect this driving, bearing in mind that the Go Kart weighs in the range of 200 to 500 lbs. depending upon its configuration.

The frame assembly, as well as most of the other linkages shown in the drawings, are constructed of tubular steel, one inch by one inch having a gauge of approximately 0.058 to 0.125 inches.

The frame assembly, as well as the four bar linkage 20 and the forward wheel carriage linkage 24, are all constructed of the same tubular material and all are welded constructions except where the pivots are attached, which are effected by slotted pivot rods as shown.

The frame 15 includes a pair of spaced parallel frame members 28 and 29, four rearwardly positioned vertical frame members 30, 31, 32, and 33, welded respectively to frame members 28 and 29 so that they are fixed thereto. Another pair of spaced horizontal frame members 36 and 37 are welded to the tops of the frame members 30, 31, 32, and 33, and extend rearwardly from the frame members 30 and 32, and these are connected at their rear ends by a cross member 39 welded to the rear end of the rearwardly extending members 36 and 37. The rear wheel assemblies 16 include rotatable caster assemblies 41 that are carried by the under carriage at the juncture of the frame members 36 and 37 with the cross member 39 so that the wheels 42 may pivot.

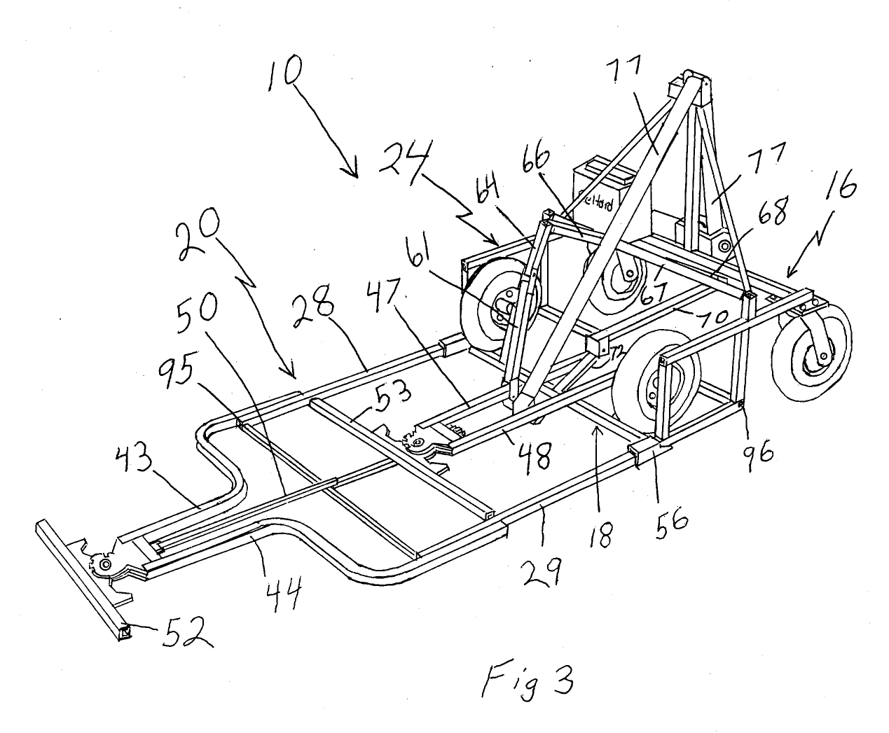

The four bar linkage 20 includes a first link defined by a fixed pair of forward members 43 and 44, that are S-shaped in configuration and pivot at 45 to the frame members 28 and 29 at their lower ends. Four bar linkage 20 also includes a second link defined by a pair of L-shaped rear members 47 and 48 pivoted at 49 and 50a to the juncture of frame members 28 and 31 and 29 and 33 respectively. The forward members 43 and 44 and the rear members 47 and 48 are interconnected by a linkage 50 that provides the required parallelogram movement of the four bar linkage illustrated sequentially in FIGS. 3, 4, 5, and to the complete upright position illustrated in FIG. 2. The linkage 50 is the third link and the frame members 28 and 29 constitute the fourth link in the four bar linkage. A first cross bar 52 is mounted on the forward link pivot mechanism 21, and a longer second cross bar is mounted on the rear cross member 53. The cross members 52 and 53 engage and support the underside of the frame of the go kart 11 during the lifting process and in the fully upright position illustrated in FIG. 2.

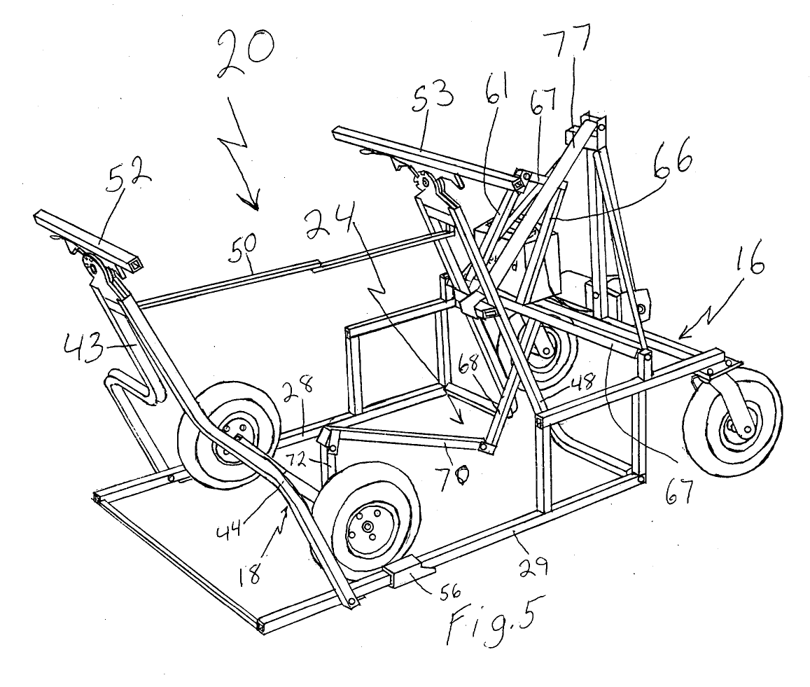

The forward wheel carriage assembly 18 includes a cross bar 55 pivoted on a pair of slides 56 that ride on the frame members 28 and 29 and permit the carriage assembly to slide from the position shown in FIG. 3, its rearmost position, to the position shown in FIG. 2. The wheels 58 are rotatably mounted on the ends of arms 59, which are welded at 60 to the cross member 55. The pivotal mounting of the cross member 55 to the slides 56 enables the wheel carriage assembly to rock counter-clockwise from the position shown in FIG. 5 to the position shown in FIG. 2, to elevate the frame members 28 and 29 and the entire frame 15 in a clockwise direction spaced above the ground or floor.

The forward wheel assembly 18 slides back and forth on the frame members 28 and 29 by the linkage 24, which is essentially a five bar linkage including a first link 61 pivoted to four bar link member 47 at 48, and it extends rearwardly therefrom, and is pivotally connected at 63 to a short downwardly extending link 64 illustrated in FIG. 6, which in turn is fixed welded at 65 to a forwardly extending link 66 welded to cross bar 67, which is pivotally fixed to the rearwardly extending members 36 and 37. This linkage 24 further includes a forwardly extending link 68 welded at its rear end to cross member 67 and pivotally connected at 69 to another forwardly extending link 70, which is pivotally connected at 71 to a short link 72, which is welded at its distal end to cross member 55.

The power drive mechanism 26, as seen in FIG. 6, includes a battery 74 mounted on a battery mount 75 carried by cross frame member 39, an electric motor 75a that drives a pulley assembly 76, that carries a belt 77, which extends over a pulley 78 mounted at the top of a fixed vertical frame member 79 welded at its lower end to cross member 39, and the belt extends forwardly and is looped around a cross member 81 fixed between frame members 47 and 48. The belt 77 pulls the rear link members 47 and 48 upwardly, driving the four bar linkage 20. The four bar linkage 20 drives the forward wheel carriage 18 through the linkage 24 because link 61 is carried by the link 47 as seen in FIG. 6.

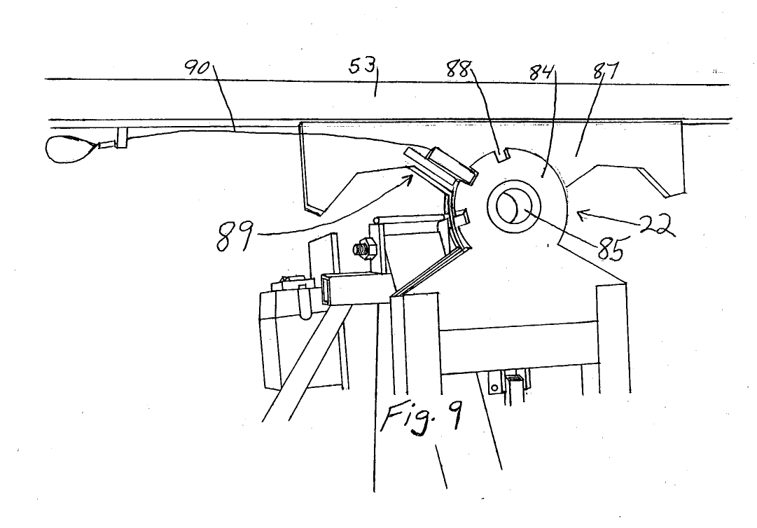

As seen in FIG. 9, the pivot mechanisms 21 and 22 include a pair of spaced semi-circular plates 84 welded together by tube 85 and which pivotally mounts a cross frame plate 87. Plates 84 have recesses 88 that receive a detent mechanism 89 that holds the cross members 53 in the 45 degree position illustrated in FIG. 1, or the horizontal position shown in FIG. 9. The detent mechanisms are operated by a cable mechanism 90. These pivot mechanisms 21 and 22 are identical.

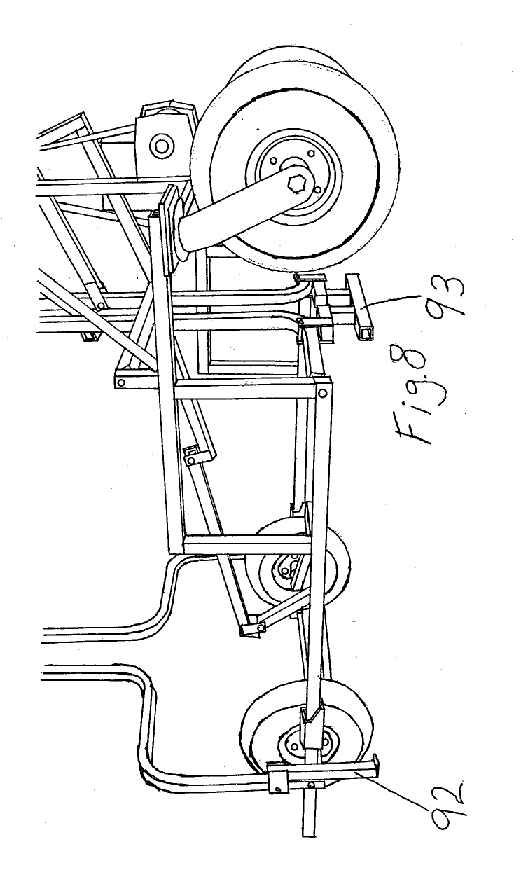

As seen in FIG. 8, a forward leg assembly 92 and a rear leg assembly 93 are provided for lifting the stand 10 off the floor of a vehicle during transportation.

Viewing FIG. 3, the lift/stand 10 is illustrated in its lowermost position in preparation for lifting the kart. The Kart may be either rolled over the assembly 10 rearwardly from in front of the cross member 52 or the lift mechanism may be slid under the Kart preferably from the rear of the kart. In this lowermost position, the forward ends 95 of the cross members 28 and 29, engage the ground while the rear ends 96 of these frame members are spaced above the ground. The forward wheel carriage 18 is pivoted counter-clockwise sufficiently so that the wheels 50 are rotated upwardly off the ground. The forward link members 43 and 44 lie on the ground as does the cross member 52. The rear four bar link members 47 and 48 are slightly off the ground because they pivot at 96 on the frame assembly but the cross member 53 connected thereto lies on the ground. In this way the entire four bar linkage presents a very low profile that can slip under the frame of a low clearance vehicle.

The four bar linkage 20 essentially is a moving parallelogram as one can see by scanning FIGS. 3, 4, 5, and 2 in sequence.

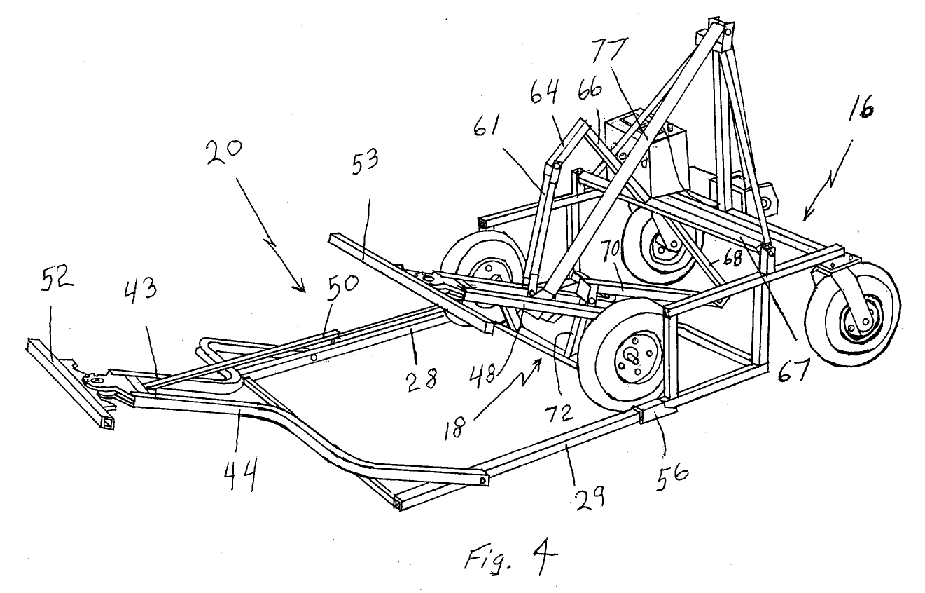

Moving in sequence from FIG. 3 to FIG. 4, the belt 77 draws the members 47 and 48 upwardly to the position shown in FIG. 4, which drives the forward members 43 and 44 upwardly to the same angle (about 30 degrees) through axial link 50. At the same time, the rear member 47 in the four bar linkage drives the wheel assembly 18 slightly forwardly from the position shown in FIG. 3, as slides 56 begin traveling forwardly on frame members 28 and 29. This occurs because the link 61 begins moving upwardly causing link 64 to move rearwardly and link 66 to pivot across member 67 causing link 68 to rotate clockwise, link 70 to move forwardly, and link 72 to push the wheel carriage forwardly.

Further pulling by belt 77 toward the FIG. 5 position causes the four bar linkage to move to an angle of approximately 70 degrees from the horizontal and the forward wheel assembly 18 to travel toward the link members 43 and 44 as the cross bar 67 rotates further driving link 68 clockwise, link 70 further forwardly, and link 72 toward an almost vertical position.

As the forward wheel carriage 18 moves from the FIG. 5 position toward the fully upright position in FIG. 2, the slides 56 hit a stop near the juncture of the links 43 and 44 and the cross members 28 and 29 causing the forward carriage 18 to cease its forward motion. However, the linkage 24 continues movement after the slides 56 engage the stop causing link 72 to rotate from its nearly vertical position in FIG. 5 to the counter-clockwise position illustrated in FIG. 2 approximately 30 degrees forwardly from vertical. This action causes the carriage 18 to rotate in a counter-clockwise direction engaging the wheels 58 with the ground and lifting the frame members 28 and 29 from their forward ground engaging position to the position illustrated in FIG. 2. In this position, the frame members 28 and 29 are parallel to the ground and the forward end of the lift/stand 10 is supported entirely by the wheels 58.

Lowering movement is the exact opposite of the lifting motion described above, except that it is assisted by the weight of the vehicle.

1. A low clearance vehicle lift/stand for a vehicle having a frame, comprising; a lift/stand structure having a forward end and a rear end including a multiple bar linkage that will slide under relative to the frame of the low clearance vehicle, a power or manual device for rotating the multiple bar linkage to raise the vehicle to a more serviceable elevation, a pair of wheels mounted on the lift/stand structure at one end thereof, and a second pair of wheels on the lift/stand structure movable from a first position to a second position elevating the lift stand structure forward end.

2. A low clearance vehicle lift/stand as defined in claim 1, including an operating mechanism for simultaneously operating the multiple bar linkage and the second pair of wheels.

3. A low clearance vehicle lift/stand as defined in claim 1, wherein the multiple bar linkage is a four bar linkage.

4. A low clearance vehicle lift/stand as defined in claim 2, wherein the operating mechanism includes a second multiple bar linkage for driving the second pair of wheels.

5. A low clearance vehicle lift/stand as defined in claim 4, wherein the second multiple bar linkage is driven by the first multiple bar linkage.

6. A low clearance vehicle lift/stand as defined in claim 5, wherein the first multiple bar linkage is at least a four bar linkage and the second multiple bar linkage is at least a five bar linkage.

7. A low clearance vehicle lift/stand for a vehicle having a frame, comprising; a lift/stand structure having a forward end and a rear end including a multiple bar linkage that will slide under relative to the frame of the low clearance vehicle, a power or manual device for rotating the multiple bar linkage to raise the vehicle to a more serviceable elevation, a pair of wheels mounted on the lift/stand structure at one end thereof, and a plurality of attachment legs for the structure to elevate the lift/stand structures and vehicle while in a trailer bed.

8. A low clearance vehicle lift/stand as defined in claim 1, including a plurality of cross bars of the structure engageable with the vehicle frame, and a tilting mechanism for the cross bars to facilitate work on the vehicle.
